(19) United States
(12) Patent Application Publication
(10) Pub. No.: US 2006/0191777 A1
(43) Pub. Date: Aug. 31, 2006

(54) Flow control device with flow adjustment mechanism

(76) Inventor: William H. Glime, Painesville, OH (US)

Correspondence Address: CALFEE HALTER & GRISWOLD, LLP, 800 SUPERIOR AVENUE, SUITE 1400, CLEVELAND, OH, 44114, US

(21) Appl. No.: 11/357,395

(22) Filed: Feb. 17, 2006

Related U.S. Application Data
(60) Provisional application No. 60/654,114, filed on Feb. 18, 2005.

(51) Int. Cl. H01H 35/26

(52) U.S. Cl. 200/81 R

(57) ABSTRACT

A valve actuator includes a stroke adjustment mechanism. An example includes a piston disposed in an actuator housing and having a range of motion or stroke between a first position and a second position. An adjustment mechanism defines a limit position of the piston, between the first and second positions. The adjustment mechanism includes a limit setting component and an adjustment component. The limit setting component is positioned to set an initial limit position to limit the range of motion of the piston to between the initial limit position and the second position. The adjustment component is moved to adjust the limit position to a position between the initial limit position and the second position to adjust the range of motion of the piston.

### RELATED APPLICATIONS

This application claims the benefit of U.S. Provisional Application No. 60/654,114, filed Feb. 18, 2005, the entire disclosure of which is incorporated by reference.

### FIELD OF THE INVENTION

The present invention relates to a flow control device with a flow adjustment mechanism. The device may be, as examples, a valve or a valve actuator.

### BACKGROUND OF THE INVENTION

Many flow control devices for fluids are adjustable. For example, a device, such as a valve or regulator, may be opened to a greater or lesser degree, to set a flow for the device.

Many flow devices in the form of regulators or valves utilize pneumatic actuation to control whether the valve is opened or closed. A typical pneumatic actuator contains one or more pistons that are coupled to a valve diaphragm to move the diaphragm against a valve seat to close the valve. Valves can be normally closed or normally opened. In a normally closed valve, a spring biases the piston and thus the diaphragm against the valve seat to maintain it closed. To open the valve, air pressure is fed into the actuator and acts on a piston face to move the piston against the spring force. As the actuator piston moves, it allows the diaphragm to disengage from the valve seat thereby opening the valve to flow. In typical prior art actuators, the piston is provided with additional travel distance to ensure that the actuator, and valve, is fully open. In this arrangement, the actuator moves the diaphragm between fully opened and closed positions.

Other diaphragm valves use different types of actuation, other than pneumatic actuation. For example, hydraulic and solenoid (electric) actuators are sometimes used with diaphragm valves. In addition, some valves use return springs, so that the actuator need provide force on the piston in only one direction of piston movement. Other types of valves do not use springs and so are considered dual actuation valves.

US Patent Publication 2004/0244850 A1 describes a valve actuator with an adjustable stop, i.e., a stroke limiter. In some embodiments, either one or two nuts are threaded on a stem for limiting the inward (closing) or outward (opening) movement of the stem and thereby of a piston. In other embodiments, either one or two nuts are adjustably threaded in an internally threaded bore, and are settable to limit the outward (opening) movement of a piston.

### SUMMARY

In one aspect the present invention relates to a flow control device having a fluid flow, including a first flow adjustment mechanism that is adjusted to set a maximum flow for the flow control device, and a second flow adjustment mechanism that is adjusted separately from the first mechanism to set a flow for the flow control device that is less than the maximum flow.

In another aspect, the invention relates to a method of controlling fluid flow in a fluid flow control device, including the steps of adjusting a first flow adjustment mechanism to set a maximum flow for the flow control device, and adjusting a second flow adjustment mechanism separately from the first mechanism to set a flow for the flow control device that is less than the maximum flow.

In another aspect, the present invention relates to an actuator for a valve, including a member having a range of motion between a first position and a second position. The member position controls flow through the valve. A first flow adjustment mechanism is adjusted to set a maximum flow for the valve. A second flow adjustment mechanism is adjusted to set a flow for the valve that is less than the maximum flow.

The invention thus provides flow devices that are factory calibrated to have the same maximum flow rate. The invention further enables customers to be able to purchase a number of such equally-calibrated flow devices, that can all thereafter be user-adjusted in a controlled manner to the same setting other than maximum.

An example of one flow device with which the invention may be used is an actuator that includes an actuator housing, a piston, and an adjustment mechanism. The piston is disposed in the actuator housing and has a range of motion or stroke between a first position and a second position. The adjustment mechanism defines a limit position of the piston that is between the first and second positions. The adjustment mechanism includes a limit setting component and an adjustment component. The limit setting component is positioned relative to the adjustment component to set an initial limit position, thereby to limit the range of motion or stroke of the piston to a range between the initial limit position and the second position. The adjustment component can be moved, moving the limit setting component, to adjust the limit position to a marked position between the initial limit position and the second position, to adjust the range of motion of the piston. The flow device is scalable—that is, the flow of the device can be set using a calibrated scale that relates the flow of the device to the position of the control knob relative to the scale.

Another example of such an actuator includes an actuator housing, a piston, and an adjustment mechanism. The piston is disposed in the actuator housing and has a range of motion or stroke between a first position and a second position. The adjustment mechanism defines a limit position of the piston that is between the first and second positions. The adjustment mechanism includes a limit screw threaded in a manually rotatable knob that is itself threaded in the housing. The limit screw is positioned relative to the knob to set an initial limit position, thereby to limit the range of motion or stroke of the piston to a range between the initial limit position and the second position. The knob can be rotated and thus moved axially, moving the limit screw also, to adjust the limit screw to a position between the initial limit position and the second position, to adjust the range of motion of the piston.

### BRIEF DESCRIPTION OF THE DRAWINGS

Further advantages and benefits will become apparent to those skilled in the art after considering the following description and appended claims in conjunction with the accompanying drawings, in which:

FIG. 1A is a schematic illustration of a flow control device, shown in a first condition;

FIG. 1B is a schematic illustration of the flow control device of FIG. 1A, shown in a second condition;

FIGS. 2A-3B are a schematic illustrations of the flow control device of FIG. 1A including a flow adjustment mechanism;

FIG. 4 is a view taken generally along line 4-4 of FIG. 2A;

FIG. 5 is a view taken generally along line 5-5 of FIG. 3A;

FIG. 6 is a sectional view of a valve actuator that includes a flow adjustment mechanism;

FIG. 7 is a sectional view of a valve actuator that includes a flow adjustment mechanism;

FIG. 8 is a sectional view of a valve actuator that includes a flow adjustment mechanism;

FIG. 9 is a schematic illustration of a valve assembly that includes a flow adjustment mechanism;

FIG. 10 is a schematic illustration of a valve assembly that includes a flow adjustment mechanism;

FIG. 11 is a schematic illustration of a valve assembly that includes a flow adjustment mechanism; and

FIG. 12 is a schematic illustration of a valve assembly that includes a flow adjustment mechanism.

FIGS. 13 and 14 are schematic illustrations of a fluid flow control device that is another embodiment of the invention; and

FIGS. 15 and 16 are schematic illustrations of a fluid flow control device that is still another embodiment of the invention.

### DETAILED DESCRIPTION

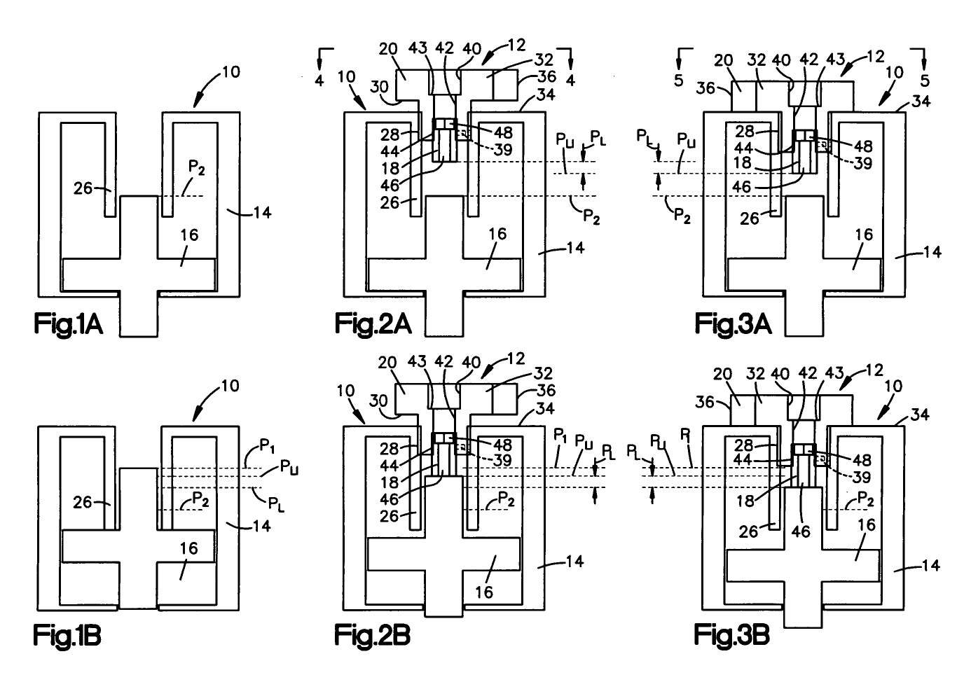

As illustrated schematically in FIGS. 1A, 2A and 3A, in one aspect, the invention relates to a flow control device 10 having a fluid flow. A first flow adjustment mechanism 18 is adjusted to set a maximum flow for the flow control device 10. A second flow adjustment mechanism 20 is adjusted separately from the first mechanism 18, to set a flow for the flow control device 10 that is less than the maximum flow rate.

In another aspect, the invention relates to a method of controlling fluid flow in the fluid flow control device 10. The method includes the steps of adjusting the first flow adjustment mechanism 18 to set a maximum flow for the flow control device 10, and adjusting the second flow adjustment mechanism 20 separately from the first mechanism to set a flow for the flow control device that is less than the maximum flow.

The present invention may as one example be embodied in flow control devices such as valve actuators for use with valves for controlling fluid flow, and in that aspect is applicable to valves and actuators of differing constructions. The illustrated embodiments show pneumatic actuators. The invention is also applicable to other types of actuators, including but not limited to hydraulic and solenoid (electric) actuators. The illustrated embodiments show valves with return springs. The invention is also applicable to other types of valves, for example, valves that do not use spring (dual actuation valves).

FIGS. 1A-3A and 1B-3B illustrate a valve actuator 10 that includes a stroke adjustment mechanism 12. The valve actuator 10 includes an actuator housing 14, a piston 16, and the adjustment mechanism 12. The piston 16 is disposed in the actuator housing 14 such that the piston has a range of motion between a first position P1 (retracted position shown in FIG. 1B) and a second position P2 (extended position shown in FIG. 1A). The designation of the illustrated positions as first and second positions is arbitrary. That is, the extended position illustrated by FIG. 1A can be designated as the first position and the retracted position illustrated by FIG. 1B can be designated as the second position. The piston may be biased to either the position illustrated by FIG. 1A or the position illustrated by FIG. 1B by a biasing member such as a spring.

As shown in FIGS. 2A, 2B, 3A, and 3 C, the adjustment mechanism 12 defines a range of limit positions PL that can be selected to limit the stroke of the piston. The adjustment mechanism includes a limit setting component or stroke limiting member 18, and an adjustment component or positioning member 20. The position of the limit setting component 18 sets an initial limit position PL1 of the actuator between the first position and the second position. The limit setting component limits the range of motion of the piston to between the initial limit position PL1 and the second position P2. The adjustment component 20 is movable relative to the actuator housing 14, to adjust the limit position PL to positions between the initial limit position PL1 and the second position P2, to adjust the range of motion of the piston. In the example illustrated by FIGS. 1A-3A and 1B-3B, the piston has a stroke from position P1 (FIG. 1B) to position P2 (FIG. 1A) before the adjustment mechanism is assembled with the actuator.

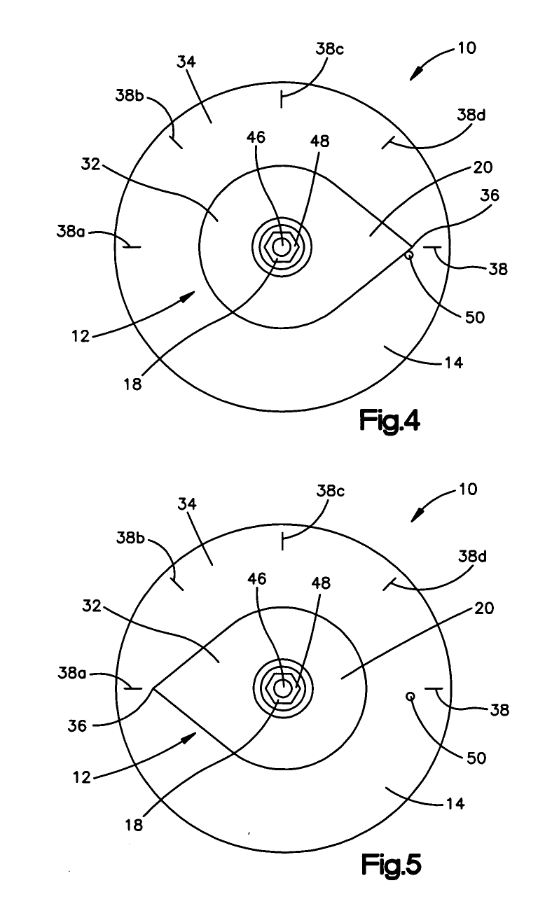

In the example of FIGS. 1A-3A and 1B-3B, the actuator housing 14 includes an internally threaded channel 26 and the adjustment component 20 has an externally threaded portion 28. In the example, the adjustment component 20 is assembled with the actuator housing by inserting the externally threaded portion 28 into the threaded channel and rotating the adjustment component with respect to the actuator housing 14 until the adjustment component 20 is at a desired position. For example, the adjustment component may be assembled with the actuator housing 14 such that a bottom 30 of an adjustment component cap 32 is spaced from a top 34 of the actuator housing as shown in FIG. 2A, and such that an adjustment component indicator 36 is aligned with indicia 38 on the top of the actuator housing as shown in FIG. 4.

In the exemplary embodiment, the indicia 38 represents a maximum flow that will be allowed by the stroke adjustment mechanism 12. Additional indicia may be included on the top of the actuator housing to assist a user in setting the flow. In the example of FIGS. 2A, 2B, 3A, 3B, indicia 38a represents a minimum flow that corresponds to the position of the piston shown in FIG. 3B. In one embodiment, indicia 38a corresponds to a position of the adjustment member where the valve controlled by the actuator is closed. In this embodiment, indicia 38b corresponds to the position where the valve is 25% open, indicia 38c corresponds to the position where the valve is 50% open, indicia 38d corresponds to the position where the valve is 75% open, and indicia 38 represents the maximum flow allowed.

During assembly of the adjustment mechanism 12 into the housing 14, the selected position of the adjustment component 20 is maintained and the limit setting component 18 is assembled with the adjustment component to set an initial limit position PL1. In the exemplary embodiment, the initial limit position corresponds to the flow indicated by the indicia 38. In one embodiment, the initial limit position corresponds to the maximum flow that can be allowed by the stroke adjustment mechanism 12. Once the limit setting component 18 is assembled with the adjustment component to set the initial limit position PL1, the position of the limit setting component is fixed with respect to the stroke adjustment component. For example, the relative position of the limit setting component may be set with respect to the adjustment component by applying a thread locking compound to threads of the limit setting component; alternatively, a locking mechanism, such as a set screw 39 (FIG. 2A), may be used to fix the relative positions.

In the example of FIGS. 1A-3A and 1B-3B, the adjustment component 20 includes an air inlet port 40 and an internally threaded channel 42. A shoulder 43 is defined between the inlet port 40 and the threaded channel 42. The illustrated limit setting component 18 includes external threads 44. An air passage 46 and tool recess 48 extend through the limit setting component 18. The tool recess accepts a tool, such as a hex drive, that is used to adjust the relative position of the limit setting component with respect to the adjustment component 20. The air passage 46 communicates pressurized air from the inlet port 40 to an actuator chamber, either above or below the piston depending on the bias of the piston.

In the example, the limit setting component 18 is assembled with the adjustment component 20 by inserting the external threads 44 into the threaded channel 42 and rotating the limit setting component with respect to the adjustment component until the limit setting component is at a desired position relative to the adjustment component. In the exemplary embodiment, the limit setting component 18 is positioned with respect to the adjustment component such that when the piston engages the limit setting component 18 and opens a valve, the valve provides the flow indicated by the indicia 38.

As shown in FIGS. 2A, 2B, 3A, 3A, 3B, 4 and 5, once the position of the limit setting component 18 is fixed with respect to the adjustment member 20, the stroke of the actuator 10 may be adjusted by rotating the adjustment component 20. For example, rotating the adjustment component 20 from the position illustrated by FIGS. 2A, 2B and 4 to the position illustrated by FIGS. 3A, 3B and 5 adjusts the axial position of the limit setting component 128, thereby to adjust the stroke limit PL from the position illustrated in FIG. 2B to the position illustrated in FIG. 3B. The stroke can be set to any of the positions in the stroke limit range PL. The stroke can be reset to the initial stroke limit PL1 by rotating the adjustment component back to align the indicator 36 with the indicia 38. In the example illustrated by FIGS. 2A, 2B, 3A, 3B, 4 and 5, the pitch of the threads 26, 28 is selected such that one-half turn of the adjustment component results in the amount of stroke adjustment illustrated between FIGS. 2B and 3B. The pitch of the threads 26, 28 can be selected to provide any desired axial travel of the stroke limiting component 18 per degree of rotation of the adjustment component 20. The actuator 10 is thus scalable—that is, the flow may be set using the calibrated scale of indicia, which relate the flow to the position of the adjustment component relative to the indicia.

In the embodiment illustrated by FIGS. 4 and 5, a stop 50 is included to prevent setting the stroke limit to an axial position that is beyond the initial stroke limit PL1. One example of a stop is a pin that extends upward from the actuator housing. The stop prevents the adjustment mechanism from allowing the piston to move to a position between the initial limit position PL1 and the first position P1. Such a stop 50 may prevent the stroke limit from being set to a position where the actuator would separate from the valve (see FIG. 10). The stop could also be used to prevent the stroke limit from being set to a position where an excessive amount of fluid would flow through the valve. In one embodiment, the stop 50 is not included. In this embodiment, the initial stroke limit PL1 may be set such that the stroke can be substantially adjusted above and below the initial stroke limit.

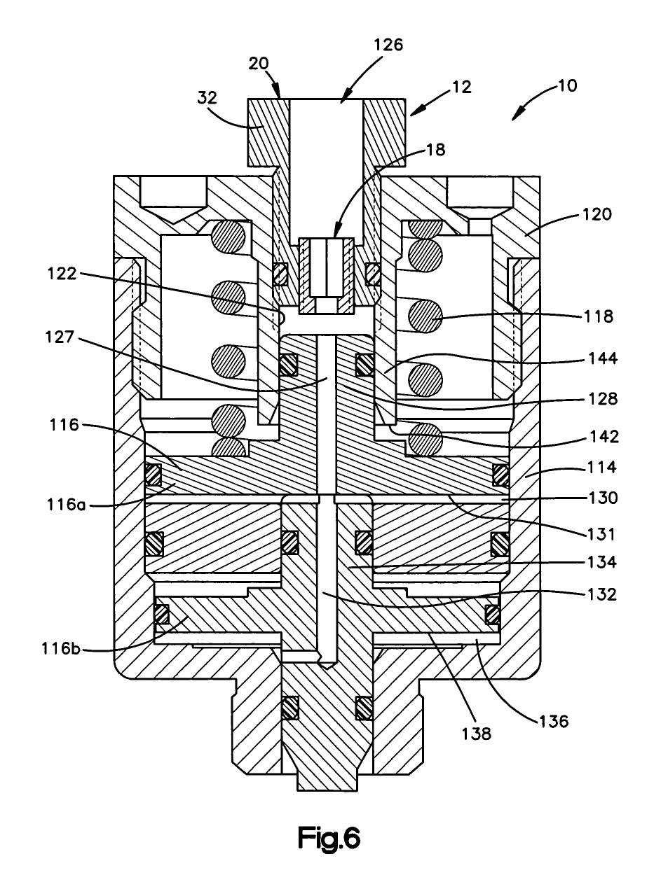

FIGS. 6-8 are sectional views of an example of an actuator 10 that includes a stroke limit adjustment mechanism 12. In the example illustrated by FIGS. 6-8, the actuator 10 is a normally closed actuator, although the stroke limit adjustment mechanism 12 could be applied to a normally open actuator. The actuator 10 includes an actuator housing 114, one or more pistons 116, a biasing member 118 such as the illustrated spring, and an end cap 120 that defines a threaded actuator air inlet passage 122. The spring 118 acts on the pistons 116 to maintain them in an extended position. Although FIGS. 6-8 illustrate a multi-piston actuator assembly, the present invention can be used with a single piston actuator.

In the example illustrated by FIGS. 6-8, the stroke limit adjustment mechanism 12 sets the stroke of the pistons 116 and defines the inlet port 126 of the actuator. In one embodiment, the inlet port 126 accepts a “push-lock” tubing insert from the air supply. In one embodiment, the adjustment mechanism includes a ⅛″ NPT port adaptor for use with a product that does not incorporate flow setting. This allows the flow setting device to be retrofit onto an existing conventional actuator that has a standard ⅛″ NPT port. One benefit of an adjustment mechanism with a port adapter is that a single actuator cap design can be used with the flow setting device and with the standard device, rather than a custom actuator cap for use with the flow-setting device.

Air enters through inlet port 126 and through the flow channel 127 in the stem 128 of the upper piston 116a. Air fills the upper actuation volume 130 and acts on the surface 131 of the upper piston 116a. Air then continues through flow channel 132 in stem 134 of the lower piston 116b. Air fills the lower actuation volume 136 and acts on the surface 138 of the lower piston 116b. The air that fills the upper and lower actuation volumes 130 and 136 and acts on surfaces 131 and 138 causes the pistons 116 to move upward against the force of the spring 118.

The stroke limit adjustment mechanism 12 acts as a positive stop for the pistons 116. The position of the positive stop is initially set and may be adjusted with the stroke limit adjustment mechanism 12. FIG. 6 illustrates the stroke limit adjustment mechanism before the limit component 18 is set to a stroke limiting position. When the limit component is in the position illustrated by FIG. 6, the stroke limit mechanism 12 does not limit the stroke of the actuator. In the position illustrated by FIG. 6, the upward movement of the upper piston 116a is limited by a lower surface 142 of the inlet passage cylinder 144.

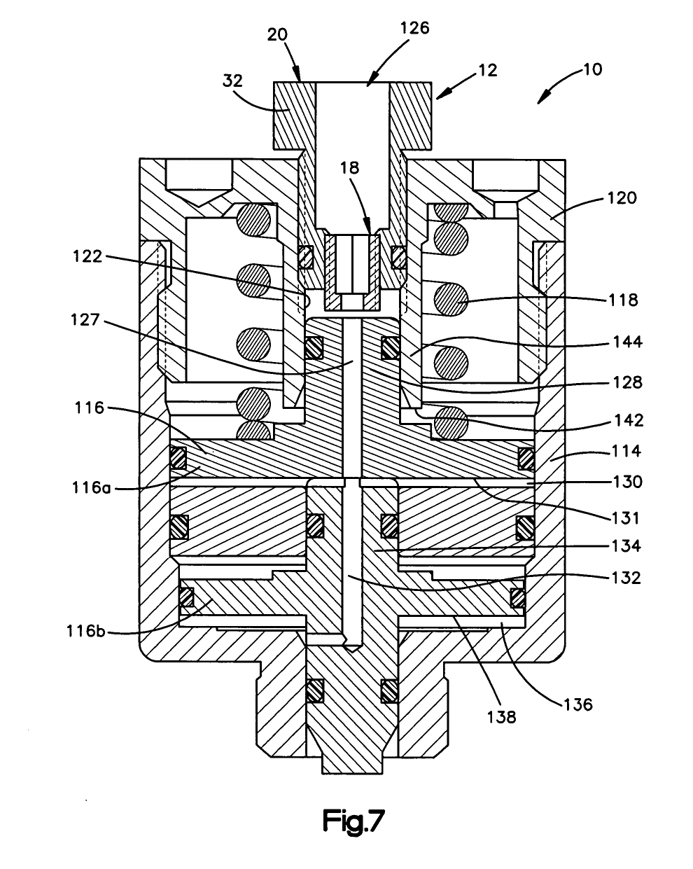

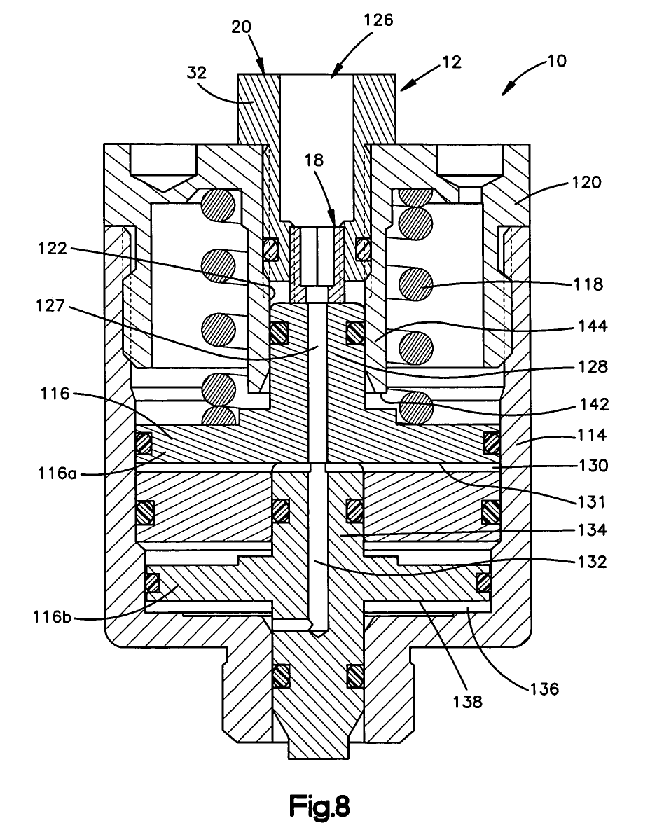

The position of the limit component 18 may be adjusted with respect to the adjustment component 20 and fixed at a selected position as illustrated by FIG. 7. In the position illustrated by FIG. 7, the upper piston 116a engages the limit member 18 before the cylinder is reached. As such, the limit member 18 limits the stroke of the piston in the position illustrated by FIG. 7. Once the position of the limit component 18 is adjusted with respect to the adjustment component, the relative position of the limit component is fixed with respect to the adjustment component. The knob 32 of the adjustment component may be turned to move the stroke limit component with respect to the actuator housing to thereby adjust the piston stroke. For example, the cap can be moved from the position illustrated by FIG. 7 to the position illustrated by FIG. 8 to further reduce the stroke of the piston. The actuator 10 is thus scalable—that is, the flow may be set using the calibrated scale of indicia, which relate the flow to the position of the knob 32 relative to the indicia.

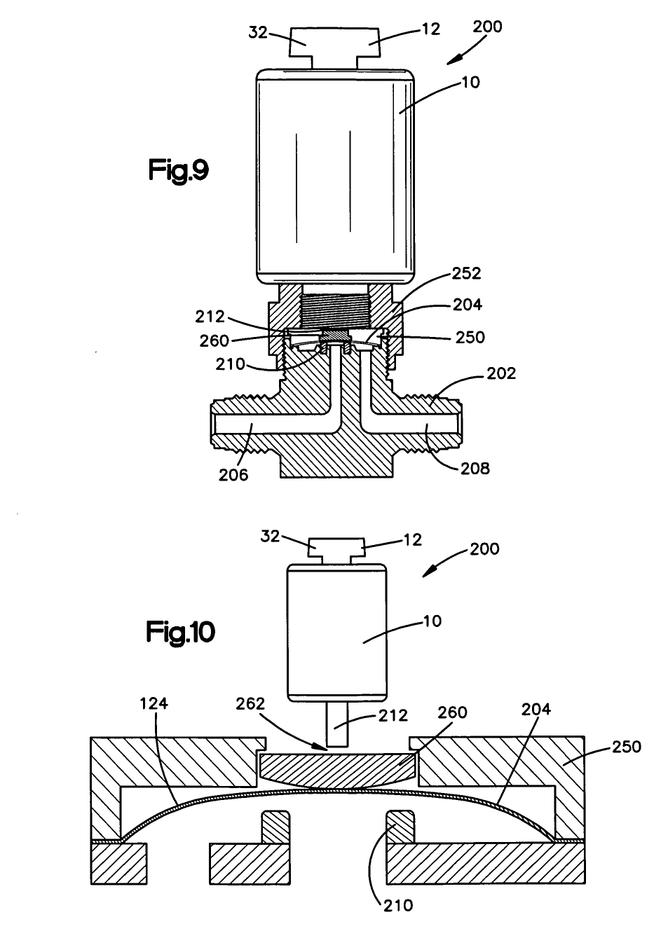

FIG. 9 illustrates an example of a valve assembly 200 that includes a valve body 202, a valve member 204, an actuator 10, and a stroke limit adjustment mechanism 12. The illustrated valve body 202 includes an inlet passage 206, an outlet passage 208, and a valve seat 210. The valve member 204 is selectively moved by the actuator 10 with respect to the valve seat 210 to alter flow from the inlet passage 206 to the outlet passage 208. For example, the actuator 10 may move the valve member 204 between a first position in which the valve member is spaced apart from the valve seat 210 to allow flow from the inlet passage 206 to the outlet passage 208, and a second position in which the valve member contacts the valve seat to block fluid flow from the inlet passage to the outlet passage. The actuator piston has a shaft 212 that is in a force-transmitting relationship with the valve member 204, for moving the valve member with respect to the valve seat 210.

In the valve shown in FIGS. 9-12, the illustrated valve member 204 is a diaphragm that comprises a flexible metallic or polymeric member or substrate. FIGS. 9-12 illustrate a diaphragm valve as an example of one of many types of valves with which the disclosed actuator with stroke limit adjustment mechanism could be used. The disclosed actuator could be incorporated into any linearly actuated valve, including rising plug, gate, weir, and globe valve configurations.

In the example illustrated by FIG. 9, the diaphragm is assembled with the valve body 204. The diaphragm is configured for flexing into sealing engagement with the valve seat 210 and out of engagement with the valve seat to allow flow of process fluid from the inlet port 206 to the outlet port 208.

The actuator is assembled with the diaphragm assembly for selectively flexing the diaphragm into and out of engagement with the valve seat. In the example illustrated by FIG. 9, a bonnet 250 secures the diaphragm to the valve body 202. In the illustrated example, a bonnet nut 252 clamps the bonnet 250 and diaphragm to the valve body 202.

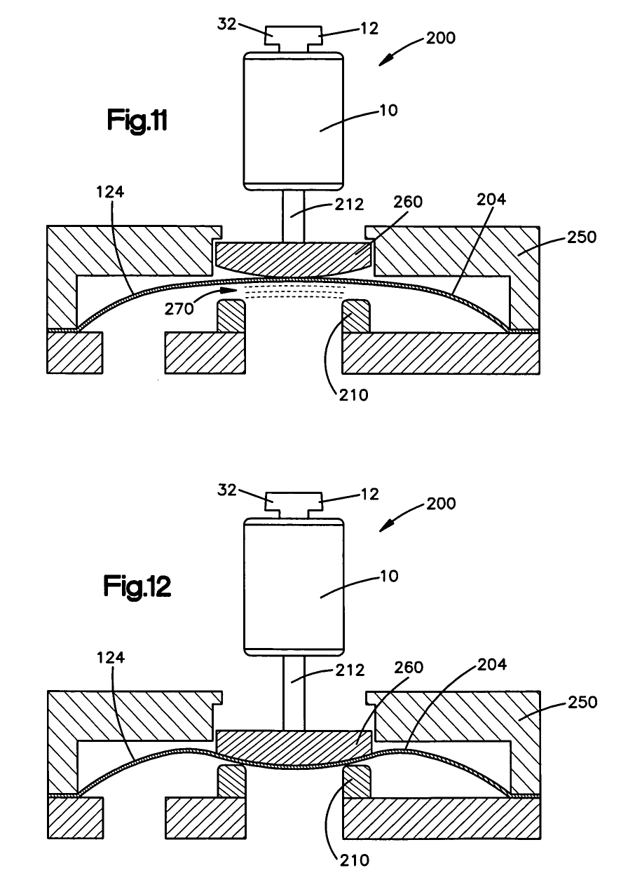

In the example illustrated by FIGS. 9-12, the actuator 10 selectively extends the actuator shaft 212 to move a button 260 along a path of travel defined by the bonnet. When the actuator shaft 212 is extended, the button 260 deflects the diaphragm into sealing engagement with the valve seat 18 (FIG. 12). When the actuator shaft 212 is retracted, the diaphragm flexes to an open state (FIGS. 10 and 11). In the example illustrated by FIGS. 9-12 the open state may correspond to the fully retracted position of the piston or to the retracted position of the piston as limited by the stroke adjustment mechanism 12.

FIG. 10 illustrates an actuator 12 with an actuator shaft 212 that does not always maintain pressure on the diaphragm. In FIG. 10 a gap or separation 262 exists between the actuator rod 212 and the actuator button 260 when the actuator rod is fully retracted by the actuator 12. This situation may occur when the actuator piston can move between the first and second positions that define the full stroke of the actuator. FIG. 11 illustrates the fully retracted position of the actuator rod with the adjustment mechanism 12 limiting the stroke of the actuator such that the separation illustrated in FIG. 10 does not occur. In the exemplary embodiment, the position illustrated in FIG. 11 corresponds to the initial limit position PL1 set by the limit component 18. The initial limit position could also be set such that the fully retracted actuator rod positions the diaphragm in any position between the position illustrated by FIG. 11 and the position illustrated by FIG. 12. In the exemplary embodiment, the knob of the adjustment component can be turned to adjust the fully retracted actuator position and thereby adjust the spacing between the diaphragm and the valve seat. For example, the adjustment component can be turned to adjust the position of the diaphragm from the position illustrated in solid lines in FIG. 11 to any of the positions illustrated by the phantom lines 270 in FIG. 11. FIG. 12 shows another embodiment in which the adjustment component can be used to manually press the diaphragm against the valve seat to manually close the valve.

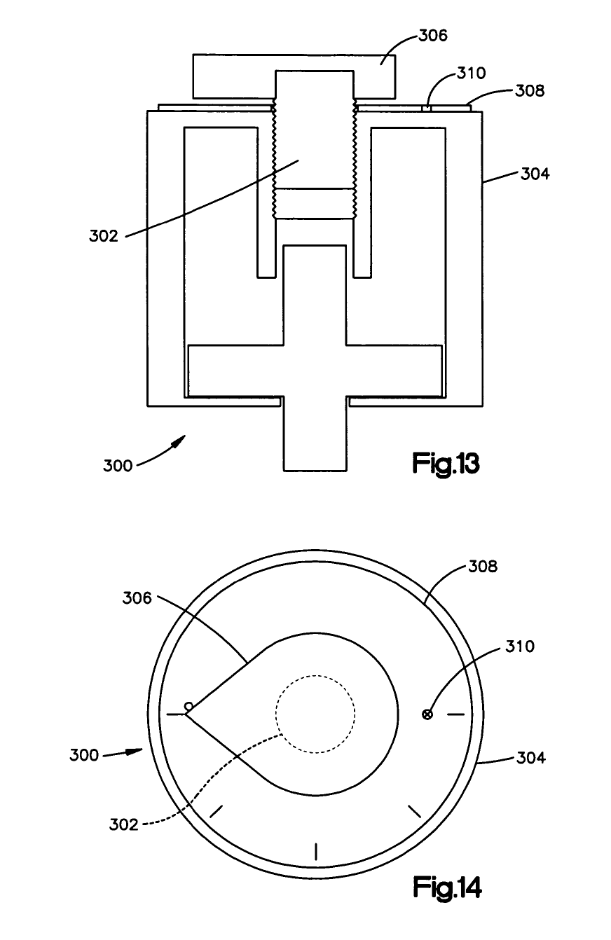

The scalability of a flow control device of the present invention may be achieved in still other, alternative, manners. One alternative involves using only a single adjustment knob/screw combined with a positionable flow scale. The single screw is contacted by the actuator piston and thus is used to limit the range of motion of the actuator piston. The device shown in FIGS. 3A and 4, for example, may be modified to the configuration of the device 300 shown in FIGS. 13 and 14 by eliminating the set screw 18 and using only a single screw 302 threaded into the housing 304 and fixedly supporting the flow-adjustment knob 306. The scale 308 is initially rotatable on the actuator housing 304. During assembly the flow control device 300 is connected to a flow measurement system, and the knob 306 and screw 302 together are adjusted to provide a target flow output from the device 300. The scale 308 is then positioned relative to the knob 306, so that that the mark on the scale that corresponds with that target flow output is aligned with the knob. The scale 308 is then locked in place on the housing as indicated schematically at 310, for example, by pinning. Subsequent movement (rotation) of the knob 306 to other positions, relative to the scale 308, will rotate the screw 302 to provide a known flow output from the device 300. Other similar devices 300 set in the same manner and having their control knobs 306 adjusted to the same position will provide a similar flow output.

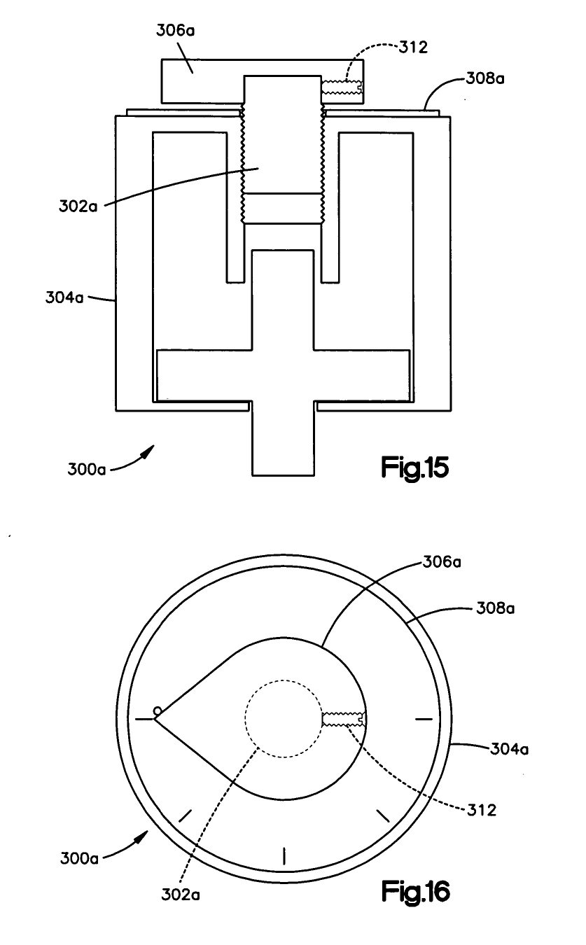

Another alternative involves using only a single adjustment screw combined with an initially fixed flow scale. The device 300 shown in FIGS. 13 and 14, for example, may be modified to the configuration of the device 300a shown in FIGS. 15 and 16. The knob 306a is initially rotatable (positionable) on the screw 302a. The scale 308a is fixed on the actuator housing 304a. During assembly the flow control device 300a is connected to a flow measurement system, and the screw 302a is adjusted to provide a target flow output from the device. The knob 306a is then positioned on the screw 302a, relative to the scale 308a, so that that the point on the scale that corresponds with that target flow output is aligned with the knob 306a. The knob 306a is then locked in place on the screw 302a, for example with a set screw 312. Subsequent movement (rotation) of the knob 306a to other positions, relative to the scale 308a, will rotate the screw 302a to provide a known flow output from the device 300a. Other similar devices 300a set in the same manner and having their control knobs 306a adjusted to the same position will provide a similar flow output.

While various aspects of the invention are described and illustrated herein as embodied in combination in the exemplary embodiments, these various aspects may be realized in many alternative embodiments, either individually or in various combinations and sub-combinations thereof. Unless expressly excluded herein all such combinations and sub-combinations are intended to be within the scope of the present invention. Still further, while various alternative embodiments as to the various aspects and features of the invention, such as alternative materials, structures, configurations, methods, devices, software, hardware, control logic and so on may be described herein, such descriptions are not intended to be a complete or exhaustive list of available alternative embodiments, whether presently known or later developed. Those skilled in the art may readily adopt one or more of the aspects, concepts or features of the invention into additional embodiments within the scope of the present invention even if such embodiments are not expressly disclosed herein. Additionally, even though some features, concepts or aspects of the invention may be described herein as being a preferred arrangement or method, such description is not intended to suggest that such feature is required or necessary unless expressly so stated. Still further, exemplary or representative values and ranges may be included to assist in understanding the present invention however, such values and ranges are not to be construed in a limiting sense and are intended to be critical values or ranges only if so expressly stated.

Having described the invention, I claim:

1. A flow control device having a fluid flow, comprising:
a first flow adjustment mechanism that is adjusted to set a maximum flow for the flow control device; and
a second flow adjustment mechanism that is adjusted separately from the first mechanism to set a flow for the flow control device that is less than the maximum flow.

2. A flow control device as set forth in claim 1 wherein the first flow adjustment mechanism includes a limit setting component for setting a maximum flow for the flow control device, and the second flow adjustment mechanism includes an adjustment component for adjusting the position of the limit setting component to set a flow for the flow control device that is less than the maximum flow.

3. An actuator as set forth in claim 2 wherein the adjustment component is rotatably connected to a housing of the device by a first threaded connection and the limit setting component is rotatably connected to the adjustment component by a second threaded connection, the maximum flow being set by rotating the limit setting component relative to the adjustment component, and the second flow adjustment mechanism being adjusted by rotating the adjustment component relative to the housing thereby moving the limit setting component to set a flow for the flow control device that is less than the maximum flow.

4. A flow control device as set forth in claim 1 including a piston that is movable to vary the flow of the flow control device, the first flow adjustment mechanism including a stroke limiting member that is engageable by the piston to limit movement of the piston in a first direction, the second flow adjustment mechanism being adjusted to the piston to move the stroke limiting member in a second direction opposite the first direction to further limit movement of the piston in the first direction.

5. A flow control device as set forth in claim 1 comprising:
an actuator housing, and an actuator member disposed in the actuator housing and having a range of motion between a first position and a second position;
the flow control device defining a limit position of the actuator member, to limit the range of motion of the actuator member to a range between the limit position and the second position;
the first flow adjustment mechanism including a limit setting component for setting an initial limit position of the actuator member;
the second flow adjustment mechanism including an adjustment component for adjusting the limit position to a position between the initial limit position and the second position thereby to adjust the range of motion of the actuator member.

6. A flow control device as set forth in claim 5 wherein the adjustment component is adjustably connected to the actuator housing by a threaded connection and the limit setting component is adjustably connected to the adjustment component by a threaded connection.

7. A flow control device as set forth in claim 5 wherein the initial limit position is set by rotating the limit setting component with respect to the adjustment component.

8. A flow control device as set forth in claim 5 further comprising a stop member positioned to inhibit movement of the adjustment component to a location that would allow movement of the actuator member to a position between the initial limit position and the first position.

9. A flow control device as set forth in claim 5 further comprising a coupling member that facilitates allowing adjustment of the limit setting component with respect to the adjustment component before the initial limit position is set and facilitates fixing the position of the limiting component with respect to the adjusting component after the initial limit position is set.

10. A flow control device as set forth in claim 5 wherein the adjustment component is supported on the actuator housing for rotation relative to the actuator housing, and the flow limit setting component is carried by the adjustment component and is rotatable within the adjustment component.

11. A flow control device as set forth in claim 10 wherein the adjustment component comprises a manually engageable handle for rotating the adjustment component between a series of predetermined flow positions.

12. A method of controlling fluid flow in a fluid flow control device, said method comprising the steps of:
adjusting a first flow adjustment mechanism to set a maximum flow for the flow control device; and
adjusting a second flow adjustment mechanism separately from the first mechanism to set a flow for the flow control device that is less than the maximum flow.

13. A method as set forth in claim 12 wherein the step of adjusting the second flow adjustment mechanism comprises rotating a manually engageable member relative to a housing of the device, and the step of adjusting a first flow adjustment mechanism comprises rotating a stroke limiting member relative to the manually engageable member.

14. A method as set forth in claim 13 wherein the stroke limiting member is coupled for rotation with the manually engageable member.

15. A method as set forth in claim 13 wherein the manually engageable member is a handle or knob that moves axially relative to the housing upon rotation, and the stroke limiting member is a set screw that is threaded in the manually engageable member and that moves axially and rotationally with the manually engageable member.

16. A method as set forth in claim 15 comprising the step of aligning the second flow adjustment mechanism with a flow indicia before setting the maximum flow with the first flow adjustment mechanism.

17. a method as set forth in claim 16 comprising the step of inhibiting movement of the second flow adjustment mechanism to a position that would allow flow in excess of the maximum flow that is set by the first flow adjustment mechanism

18. An actuator for a valve, said actuator comprising:
a member having a range of motion between a first position and a second position, the member position controlling flow through the valve;
a first flow adjustment mechanism that is adjusted to set a maximum flow for the valve; and
a second flow adjustment mechanism that is adjusted to set a flow for the valve that is less than the maximum flow.

19. An actuator as set forth in claim 18 wherein the member is a piston coupled for movement with a valve member that is movable relative to a valve seat to control flow through the valve;
the first flow adjustment mechanism including a stroke limiting member that is adjusted to limit the stroke of the piston to a maximum position thereby to set the maximum flow for the valve; and
the second flow adjustment mechanism including a positioning member that is adjusted separately from the first mechanism to limit further the stroke of the piston thereby to set a flow for the valve that is less than the maximum flow.

20. An actuator as set forth in claim 19 wherein the positioning member is a manually engageable rotatable member such as a handle or a knob.

21. An actuator as set forth in claim 19 wherein the positioning member is rotatably connected to a housing of the actuator by a first threaded connection and the stroke limiting member is rotatably connected to the positioning member by a second threaded connection, the maximum position of the stroke limiting member is set by rotating the stroke limiting member relative to the positioning member, and the second flow adjustment mechanism is adjusted by rotating the positioning member relative to the housing thereby causing movement of the stroke limiting member to set a flow for the valve that is less than the maximum flow.

22. An actuator as set forth in claim 18 wherein the second adjustment mechanism is selectively adjustable to a plurality of repeatable positions including a full flow position in which the stroke limiting member is at the maximum position, and at least one lower flow position.

23. An actuator as set forth in claim 18 wherein the second flow adjustment mechanism includes a manually engageable handle and the first flow adjustment mechanism includes a set screw threaded in the handle.

24. An actuator as set forth in claim 18 wherein the second flow adjustment mechanism defines an inlet port of the actuator.

25. An actuator as set forth in claim 18 wherein the valve is a normally open valve and the second flow adjustment mechanism may adjust the flow of the valve to a position where the valve is closed.

26. An actuator as set forth in claim 18 further comprising a stop member positioned to inhibit movement of the second flow adjustment mechanism to a condition that would allow flow greater than the maximum flow for the valve.

27. An actuator as set forth in claim 26 wherein the stop member comprises a pin assembled with the a housing of the actuator.

28. A method of controlling fluid flow in a fluid flow control device, comprising the steps of:
providing a rotatable limit screw having an end portion that is engageable by a movable member of the flow control device to set a limit of movement of the movable member, the screw supporting a knob;
rotating the limit screw to a position at which a desired maximum flow for the flow control device is provided; and
aligning the knob with a maximum flow indicia on a scale of a housing of the flow control device.

29. A method as set forth in claim 28 wherein:
the limit screw includes first and second relatively rotatable portions, the knob being fixed for rotation with the first screw portion, the second screw portion being engageable by the movable member;
the step of aligning the knob is performed before the step of rotating the limit screw and comprises rotating the knob and the first and second screw portions together; and
the step of rotating the limit screw to a position at which a desired maximum flow for the flow control device is provided comprises rotating the second screw portion relative to the first screw portion to a position at which a desired maximum flow for the flow control device is provided upon engagement of the movable member by the second screw portion.

30. A method as set forth in claim 29 further comprising rotating the knob and the limit screw together to align the knob with a second indicia that indicates a second flow for the flow control device.

31. A method as set forth in claim 28 wherein the aligning step includes:
rotating the scale on the housing to align the maximum flow indicia on the scale with the knob; and thereafter
fixing the scale to the housing.

32. A method as set forth in claim 31 further comprising rotating the knob and the limit screw together to align the knob with a second indicia on the scale that indicates a second flow for the flow control device.

33. A method as set forth in claim 28 wherein the aligning step includes:
rotating the knob on the screw to align the knob with the maximum flow indicia on the scale; and thereafter
fixing the knob for rotation with the limit screw.

34. A method as set forth in claim 33 further comprising rotating the knob and the limit screw together to align the knob with a second indicia on the scale that indicates a second flow for the flow control device.

35. A fluid flow control device having a predetermined maximum flow setting, the device being adjustable to a second flow that is less than the maximum flow, the device having indicia that relate the adjustment position to a predetermined flow of the flow device.

36. A fluid flow control device as set forth in claim 35 wherein the device is adjustable to the second flow and thereafter to the maximum flow in a repeatable manner.

37. A fluid flow control device as set forth in claim 35 wherein the device is a piston actuated flow control device and is adjustable to limit the stroke of the piston.

38. A fluid flow control device as set forth in claim 35 wherein the indicia relate the adjustment position to a predetermined second flow that is a known flow.

39. A fluid flow control device as set forth in claim 35 wherein the indicia relate the adjustment position to a predetermined second flow that is a known percentage of the maximum flow.

40. A fluid flow control device as set forth in claim 35 wherein the predetermined maximum flow is a factory setting.

41. A method of controlling fluid flow in a fluid flow control device, comprising the steps of:
setting a maximum flow for the device; and
using indicia associated with the device to adjust the flow of the device to a predetermined second flow that is less than the maximum flow.

42. A method as set forth in claim 41 wherein the step of setting a maximum flow for the device comprises providing a predetermined factory maximum flow setting.

43. A method as set forth in claim 41 further comprising the step of returning the device to the predetermined maximum flow in a repeatable manner.

44. A method as set forth in claim 41 wherein the step of using indicia comprises adjusting the flow to the predetermined second flow in a repeatable manner.

45. A method as set forth in claim 41 wherein the step of using indicia comprises adjusting the flow to a predetermined second flow that is a known flow.

46. A method as set forth in claim 41 wherein the step of using indicia comprises adjusting the flow to a predetermined second flow that is a known percentage of the maximum flow.
